(19) United States
(12) Patent Application Publication
(10) Pub. No.: US 2010/0208485 A1
(43) Pub. Date: Aug. 19, 2010

(54) Modular EL wire bicycle and vehicle kit

(76) Inventor: Nathan Morgans, Jacksonville, FL (US)

Correspondence Address: Nathan Morgans, 2162 Dellwood Ave. #1, Jacksonville, FL, 32204, US

(21) Appl. No.: 12/707,628

(22) Filed: Feb. 17, 2010

Related U.S. Application Data
(60) Provisional application No. 61/153,280, filed on Feb. 17, 2009.

(51) Int. Cl. F21V 21/00; B60R 11/00

(52) U.S. Cl. 362/549; 224/545

(57) ABSTRACT

A modular electroluminescent lighting kit to apply to a bicycle, car, or other vehicle for increased safety, visibility and design style. The kit is comprised of a battery driver which can be further powered by solar or kinetic devices, an EL wire or other illuminated filament configuration that conforms to the frame of the bicycle or form of the vehicle interior/exterior taking into account the areas of said vehicles that have moving parts. The kit includes basic or custom brackets to affix the wires in place in any design configuration that pleases the end user. The kit may be designed to be upgradable in modular stages and including but not limited to LED devices, motion sensing stand-alone wheel lighting, or plastic molded mountable lighting devices.

### CROSS-REFERENCE TO RELATED APPLICATIONS

This application is referencing a continuation of Provisional application No. 61/153,280 filed Feb. 17, 2009

### STATEMENT REGARDING FEDERALLY SPONSORED RESEARCH OR DEVELOPMENT

n/a

### REFERENCE TO SEQUENCE LISTING

n/a

### BACKGROUND OF THE INVENTION

Bicycle enthusiasts and children alike have a need to be lit up at night for visibility and safety. In some areas this is not just a safety concern but an issue of legal compliance. Custom car enthusiasts and average drivers both enjoy lighting elements that set them apart from the crowd. The lighting devices that are currently on the market are largely LED, or gas neon tubes. Although there exists “plug and play” EL wire units that come with a battery inverter and a length of EL wire, said “plug and play” kits do not take into account certain elements that the present invention overcomes by its configuration and/or modular ability to be expandable.

### BRIEF SUMMARY OF THE INVENTION

The first obstacle overcome by the present invention is to conform the EL wire or illuminated filament to the unique design of a bicycle frame or the interior/exterior of a car. A single wire cannot be easily wound around the entirety of the surface a vehicle owner may want to light. The present invention solves this by providing a circuit that splits lengths of EL wire or illuminated filament to correspond to specific areas of a bicycle frame or car interior/exterior. The circuit splits are done in a modular fashion combining at connection points to allow customization and expansion.

The second obstacle overcome by the present invention is that vehicles have moving parts, such as the steering column and shocks on a bicycle, and the doors and steering wheel on a car. EL wire is durable but will break and disintegrate if applied in these high movement areas. This obstacle is overcome by the present invention by combining the connection points that make the present invention modular with the high movement areas as the connection points are flexible lead wire and can be long enough to provide proper slack depending on the nature of the vehicle area.

The third obstacle taken into account in the present invention is weather. Standard EL wire is water resistant, but standard EL wire connectors are not and will short circuit if for example: bicycling in the rain or in outdoor storage conditions. The present invention solves this obstacle by using waterproofed connectors or by applying a method of waterproofing to standard connections.

A fourth issue solved by the present invention is attaching the EL wire to the bicycle frame or car interior/exterior. Several methods of bracket systems are set forth by the present invention that can be adapted in a variety of ways to achieve just about any design element wished to be illuminated in EL wire. The brackets can be adapted to be specific shapes and designs or logos, or be open ended for the end user to design their own shapes. These brackets can be attached to the bicycle frame or car in a number of ways.

Any user of the prior art will see how the present invention solves the obstacles set forth and the scope of modification while staying within the spirit of the invention.

Furthermore, although the focus of the invention is the easy application of electroluminescent lights to a vehicle, the modular nature, the configuration, and bracket system may make the current invention applicable to a multitude of surfaces defined only by the end users imagination.

### BRIEF DISCRIPTION OF DRAWINGS

FIG. 1 is a typical bicycle frame.

FIG. 2 is a schematic of the present invention, preferred embodiment to fit bicycle frame.

FIG. 3 is a bicycle wheel with a schematic of an embodiment of the invention in a spiral to fit bicycle tire.

FIG. 4 is a bicycle wheel with a schematic of an embodiment of the invention in a radial to fit bicycle tire.

FIG. 5 is a large view of a bracket 117 designed to clip EL wire to a bicycle spoke.

FIG. 6 is an overview of a car interior and a schematic of an embodiment o f the invention designed to fit a car interior.

FIG. 7 is a car steering wheel and a schematic of an embodiment of the invention designed to fit a car steering wheel.

FIG. 8 is a bracket designed to keep EL wires in place on a bicycle frame, two views.

FIG. 9 is a bracket designed to keep EL wires in a fixed straight channel with an adhesive surface, two views.

FIG. 10 is a bracket designed to bend EL wires in a fixed angle channel with an adhesive surface, two views.

FIG. 11 is a bracket designed to bend EL wires in a variety of fixed angles, or to cross two wires in a fixed cross channel with an adhesive surface, two views.

FIG. 12 is a bracket designed to bend EL wires in a variety of fixed shapes and designs, with a variety of wire clips or fixed channels, two views. Designed to fit a bicycle frame or dashboard.

FIG. 13 is a bracket designed as a bicycle grip, with fixed channels to hold EL wire. Two designs.

FIG. 14 is a molded design of a possible embodiment of a bracket system containing an array of LED's and EL wires extruding from it.

FIG. 15 is a molded design of a possible embodiment of a bracket system containing EL wire wound inside and extruding to frame mold shape.

FIG. 16 is a molded design of a possible embodiment of a bracket system containing an array of LED's and EL wires wound inside a transparent or translucent mold shape.

### DETAILED DESCRIPTION OF THE INVENTION

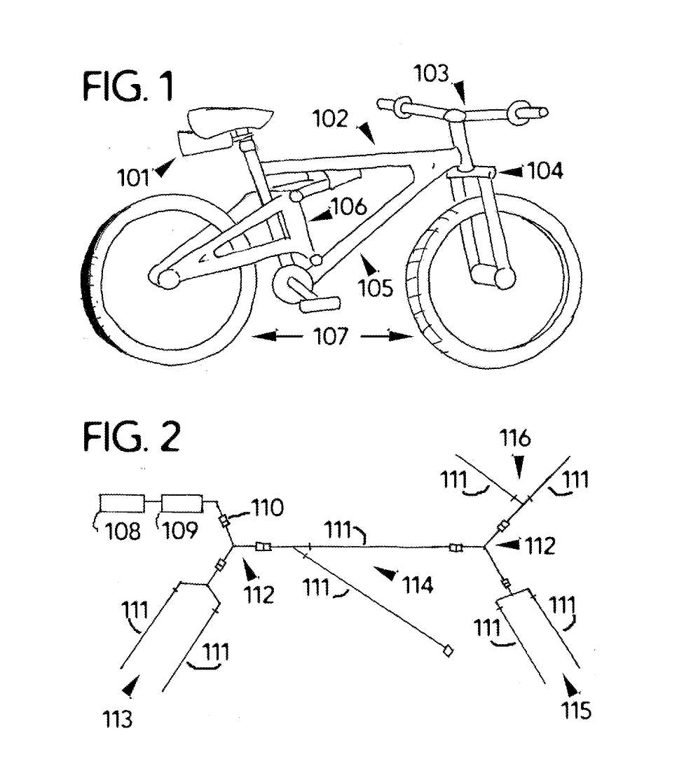

FIG. 1 is an illustration of the basic sections of a bicycle frame. It is intended to be viewed in tandem with FIG. 2 to reference what sections of the present invention correspond to specific sections of the bicycle frame. 101 is the area under a bicycle seat, or a typical seat pack designed to strap under a bicycle seat. 102 is the top bar of a bicycle frame. Although depicted is a male bike, it is referencing the corresponding bar on a female bicycle frame as well. 103 are the handle bars and steering column on a bicycle frame. 104 are the front shocks and front wheel frame bars of a bicycle. 105 is the bottom bar of the mainframe of a bicycle. 106 are the back shocks and back wheel frame bars of a bicycle. 107 is a reference to both tires on a bicycle.

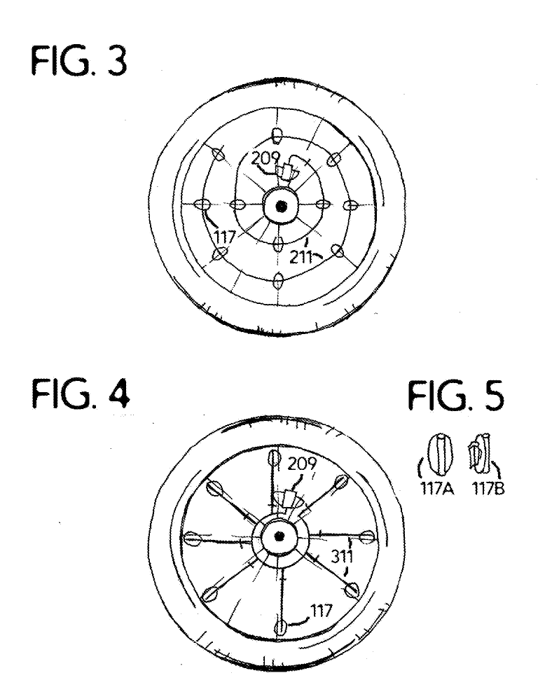

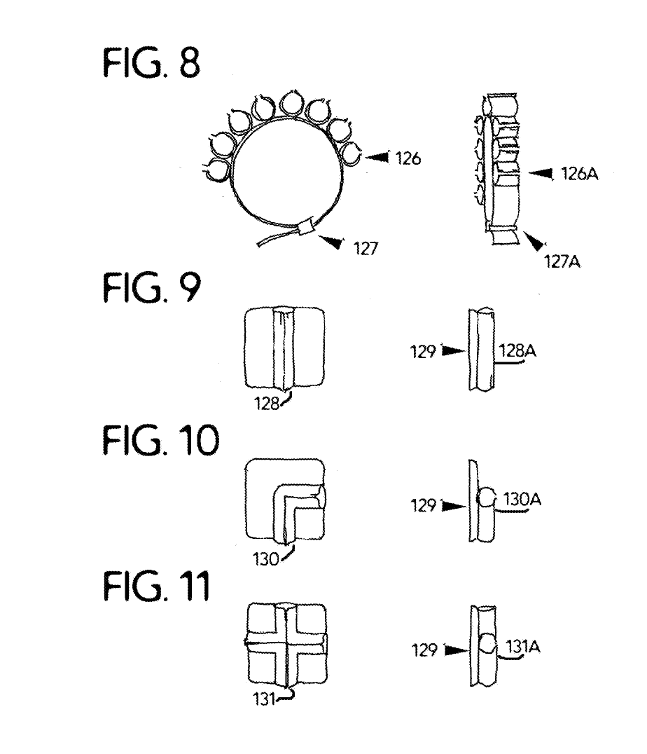

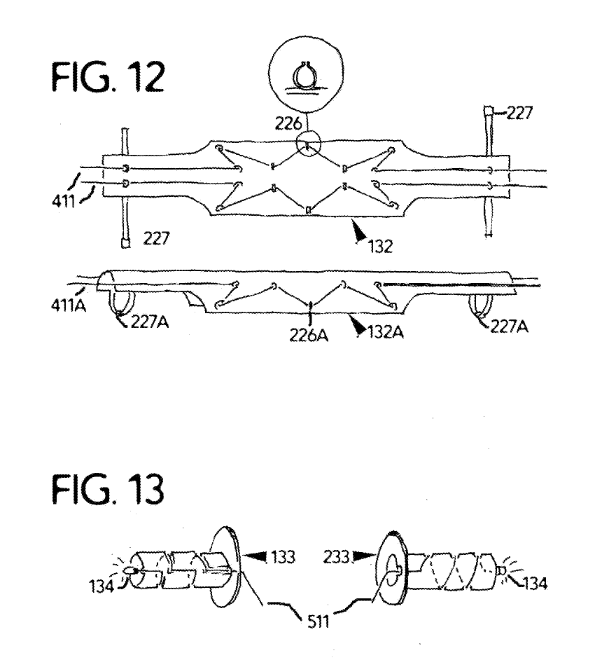

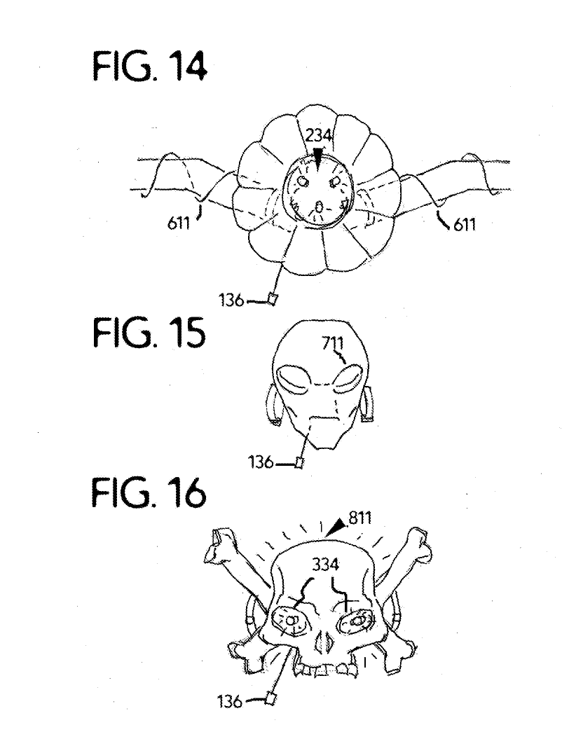

FIG. 2 is a schematic of the preferred embodiment of the invention. 111 represents a length of EL wire or illuminated filament. 108 represents a solar cell or kinetic generator. 109 represents the battery storage and electrical inverter. 108 and 109 would fit on the bicycle at section 101 FIG. 1 inside a weatherproof seat pack or weatherproofed in a unit together and clipped under bicycle seat frame. 110 represents the symbol used in the schematic for a water resistant male/female coupling connector. 112 represents a Y split connector. Said connector starts with a water resistant male connector and takes the single circuit starting at the electrical inverter and splits it to two wires ending in two water resistant female plug ends. The lead wire included in 112 gives extra length to the flexible wire to be positioned at the moving parts of the bicycle frame at sections 106,103 and 104 in FIG. 1. 112 also allows expansion of the circuit to two new sections. In this preferred embodiment the first instance of 112 splits the circuit into section 113 and 114. 113 is a section starting with a water resistant male connector end then splits into two circuits each including several inches of lead wire then ending in a length of EL wire with a water resistant cap at the end. 113 is intended to be attached to the two back bicycle wheel frame bars of section 106 in FIG. 1. 114 is a section starting with a water resistant male connector end then splits to two circuits each including several inches of lead wire then continuing in a length of EL wire with a water resistant female connector at the end of each EL wire. The two lengths of EL wire in section 114 could be different lengths and not both EL wires need to end in a female connector, but instead one could be just a water proof cap. 114 is intended to be secured to the bicycle frame at sections 102 and 105 of FIG. 1 but can be arranged as determined by the end user keeping in mind moving parts of the bicycle frame. At least one female connector end of 114 is intended to be secured near the steering column of the bicycle frame 103 FIG. 1 so that the next instance of a Y split connector 112 can be secured with enough slack for the steering to not be impeded and to split the circuit to accompany sections 115 and 116. Sections 115 and 116 are similar in circuit to each other and 113. They all split the current from a water resistant male connector end to two circuits each including several inches of lead wire then ending in a length of EL wire with a water resistant cap at the end. 115 is intended to be secured to the bicycle frame front wheel bars 104 FIG. 1. 116 is intended to be secured to each side of the handlebars 103 FIG. 1. 113 115 and 116 could all be the same length of lead wire and EL wire for easy compatibility or could be specifically designed lengths as to conform more precisely to a specific bicycle frame, style, or design. A properly built circuit as described here in FIG. 2 powered by the appropriate power inverter will light all the EL wire in the circuit brightly and provide enough slack in lead wire areas so as to not interfere with the normal operation of a bicycle. A properly built circuit as described here in FIG. 2 could be disconnected and reconnected in a variety of ways as determined by the end user, and have additional circuit arrays available to replace or add to the circuit of the preferred embodiment. Any standard or custom clip or bracket that achieves securing the wires in the intended place can be used to secure the present invention to a bicycle frame. FIG. 8 is the preferred embodiment of a bracket to secure EL wires to a bicycle frame with ease and precision. The electric inverter 109 is graded as by how much wire it can power, and can be upgradable to power further expansions of the present invention and/or as described in the other embodiments in the FIG. 12, FIG. 13, FIG. 14, FIG. 15, and FIG. 16 drawings. Include FIG. 3, FIG. 4, and FIG. 5, for the full embodiment of the present invention intended to light a bicycle frame.

FIG. 3 is an illustration of a bicycle tire with an embodiment of the invention attached to the spokes in a spiral fashion. 209 is a battery driver inverter powered by small batteries such as watch sizes or AAAs. It is preferred that this driver has a motion detection switch to only light tires when in action as to save battery charge. The battery driver inverter could have any number of effects including but not limited to strobe, flash, or sound activated. 211 is the circuit starting with the battery inverter to several inches of lead wire, ending in a length of EL wire to be enough to arrange in a spiral around the spokes of section 107 FIG. 1. The end of the EL wire should be weather capped. 117 is a preferred embodiment of a clip channel to attach the EL wire to the spokes securely in the direction intended. Any standard or custom clip or bracket that achieves securing the wires in the intended place can be used to secure present invention to bicycle frame.

FIG. 4 is an illustration of a bicycle tire with an embodiment of the invention attached to the spokes in a radial fashion. 209 is a battery driver inverter powered by small batteries such as watch sizes or AAAs. It is preferred that this driver has a motion detection switch to only light tires when in action as to save battery charge. The battery driver inverter could have any number of effects including but not limited to strobe, flash, or sound activated. 311 is the circuit starting at the battery inverter to several inches of lead wire with small sections of EL wire connected to the lead wire every few inches. This is arranged in a fashion as to where the lead wire will be attached from a point near the axle of the tire and extend out each separate length of EL wire along a spoke and the end of each EL wire will attach at a point near the inner wall of the tire in a radial pattern. 117 is a preferred embodiment of a clip channel to attach the EL wire to the spokes securely in the direction intended. Any standard or custom clip or bracket that achieves securing the wires in the intended place can be used to secure present invention to bicycle frame.

FIG. 5 is a close up view of an example of a preferred embodiment of a bracket designed to clip to a bicycle spoke and fasten an EL wire. 117A shows a view of the bracket with a channel clip to arrange an EL wire in a straight line. 117B shows a side view of the bracket featuring a spoke clip on a swivel as to move the direction of the channel clip.

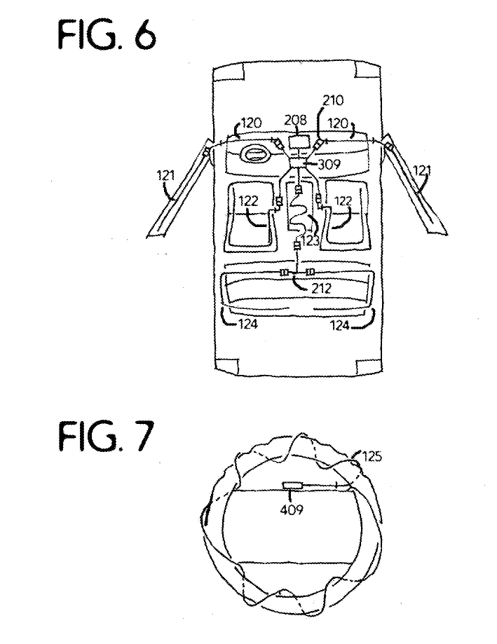

FIG. 6 is a schematic of an embodiment of the present invention adapted to fit a car interior. 208 is a solar panel. 309 is a battery storage and electrical inverter designed to be used standalone, or in conjunction with the car's battery. This electrical inverter could be a multichannel sequencer or sound activated driver for special effects. 210 is the symbol used throughout the schematic to represent a weather proofed male/female connector coupling. 120 is a length of EL wire to be used on the dashboard area, 121 is a length of EL wire to be used on the interior of the car doors. 122 is a length of EL wire to be used on or around the car seats. 123 is a length of EL wire to be used in, on, or around the car interior center console. 212 is a possible placement for a standard Y split connector. 124 is a length of EL wire to be used on, or around the back seats and back window of the car interior. Extra Y split connectors 212 or extra lengths of wire could be used easily to expand on this basic circuit, or to change out areas for further customization. A simple rearrangement of the circuit of this embodiment could make it appropriate for car exterior use. Any standard or custom clip, adhesive, or bracket that achieves securing the wires in the intended place can be used to secure this embodiment of the present invention to car interior/exterior. FIG. 9 FIG. 10. FIG. 11 and FIG. 12 are examples of preferred embodiments of brackets that would improve easy installation and customization.

FIG. 7 is a car steering wheel with a schematic of an embodiment of the present invention. This embodiment includes a battery driver inverter 409 powered by small batteries such as watch batteries or AAAs. It is preferred that this driver has a motion detection switch to only light tires when in action as to save battery charge. The battery driver inverter could have any number of effects including but not limited to strobe, flash, or sound activated. The wire could alternately be powered by the main car electrical inverter 309, FIG. 6 if plenty of lead wire was secured in the proper fashion as to not interfere with driving. 125 is a length of EL wire appropriate to wind around, or attach around, a car steering wheel.

FIG. 8 is a bracket used in the preferred embodiment of the present invention designed to strap around any section of bicycle frame. This bracket could be made of any durable moldable material. 126 is a clip channel designed with a radius as to secure any standard size of EL wire used by present invention. 126A is an alternate view of the EL wire clip channel array. 127 is a strap and secure point for the bracket. The strap and secure point can be any such securing method such as: zip tie, hook and loop, button, tab, buckle. 127A is the same strap and secure point in an alternate view.

FIG. 9 is a bracket used in an embodiment of the present invention designed to secure an EL wire in a fixed direction onto a car interior surface. 128 is a straight channel clip designed with a radius as to secure any standard size of EL wire used by present invention. 128A is an alternate view of the straight channel clip. 129 is the flat bottom surface of the bracket to be affixed with an industrial strength adhesive.

FIG. 10 is a bracket used in an embodiment of the present invention designed to secure and bend EL wires in a fixed angle channel onto a car interior surface. 130 is a fixed angle channel clip designed with a radius as to secure any standard size of EL wire used by present invention. 130A is an alternate view of the straight channel clip. 129 is the flat bottom surface of the bracket to be affixed with an industrial strength adhesive.

FIG. 11 is a bracket used in an embodiment of the present invention designed to bend EL wires in a variety of fixed angles, or to cross two wires in a fixed cross channel and secure them to a car interior surface. 131 is a cross channel clip designed with a radius as to secure any standard size of EL wire used by present invention. 131A is an alternate view of the cross channel clip. 129 is the flat bottom surface of the bracket to be affixed with an industrial strength adhesive.

FIG. 12 is a bracket used in an embodiment of the present invention designed to bend EL wires 411, 411A in a variety of fixed shapes and designs, with a variety of wire clips or fixed channels 226,226A. Designed to fit a bicycle frame or dashboard the surface shape 132, 132A can be any durable flexible material shaped to fit a bicycle bar in a tubular fashion or flat for a car interior. The surface shape 132 can house the EL wire channel clips 226 in a sturdy fixed way that can affix wires in just about any basic shape or logo depending on placement and number of channel clips 226. This bracket construct can be attached to a bicycle bar or a car interior by 227, 227A which would be straps and secure points for a bicycle, or suction cups/adhesive surface for a car. Such a bracket could be included as part of an embodiment of the present invention and/or as an expansion unit with EL wire already wired into it, or as a blank design expansion piece for the end user to apply EL wire into the channel clips 226 manually.

FIG. 13 is a bracket used in an embodiment of the present invention designed as a bicycle grip with fixed channels to hold EL wire 511.133 is one design embodiment. 233 is another design embodiment. 134 is an LED element wired at the end of the EL wire 511. Such an embodiment of the present invention could be included and/or part of an expansion unit. This embodiment would be fashioned as a cushioned bicycle grip with EL wire 511 already embedded in the grip, or with blank channels that the end user could apply EL wire to manually.

FIG. 14 is a molded design of a possible embodiment of a bracket system containing an array of LED's 234 and EL wires 611 extruding from it. In this embodiment the molded design is that of a sunflower in a transparent or translucent material. This embodiment of a lighted molded bracket could be included as part of an embodiment of the present invention and/or as an expansion unit. It is designed to be strapped to the handlebars but could be modified to fit another area of a bicycle, dashboard, car interior, or car exterior. 136 is a weather proofed male plug to power the molded bracket and is designed to plug into any of the weather proofed female plugs in any other part of the present invention.

FIG. 15 is a molded design of a possible embodiment of a bracket system containing EL wires 711 extruding from it in select places so as to outline the mouth and eyes only of an alien head. In this embodiment the design is molded in an opaque, transparent or translucent material. This embodiment of a lighted molded bracket could be included as part of an embodiment of the present invention and/or as an expansion unit. It is designed to be strapped to the handlebars but could be modified to fit another area of a bicycle, dashboard, car interior, or car exterior. 136 is a weather proofed male plug to power the molded bracket and is designed to plug into any of the weather proofed female plugs in any other part of the present invention.

FIG. 16 is a molded design of a possible embodiment of a bracket system containing an array of LED's 334 and EL wires 811 molded into it. In this embodiment the molded design is that of a skull and crossbones in a transparent or translucent material. The LEDs 334 are to light up the eyes and the EL wire lights up the mold from the inside. This embodiment of a lighted molded bracket could be included as part of an embodiment of the present invention and/or as an expansion unit. It is designed to be strapped to the handlebars but could be modified to fit another area of a bicycle, dashboard, car interior, or car exterior. 136 is a weather proofed male plug to power the molded bracket and is designed to plug into any of the weather proofed female plugs in any other part of the present invention.

While the present invention has been described in what are presently considered to be its most practical and preferred embodiments or implementations, it is to be understood that the invention is not to be limited to the particular embodiments disclosed hereinabove. On the contrary, the present invention is intended to cover various modifications and equivalent arrangements included within the spirit and scope of the claims included, which scope is to be accorded the broadest interpretation so as to encompass all such modifications and equivalent structures as are permitted under the law.

1. A lighting kit for vehicles including but not limited to: an electric power source, an EL wire and/or illuminated filament configuration designed to fit a bicycle frame, car frame, or other vehicle interior/exterior, optionally with detachable segments and segments that are flexible and durable wire to accommodate moving vehicle sections, and standard or custom brackets designed to easily affix wires, electroluminescent elements, and power source to vehicle.

2. The electric power source of claim 1 including but not limited to: being powered by a plurality of batteries or energy storage as needed.

3. The electric power source of claim 1 including but not limited to: being user controlled or pre-programmed by a sequencer to light several EL wires or illuminated filaments in an animated or blinking fashion.

4. The electric power source of claim 1 including but not limited to: being activated by a motion, sound or light sensor.

5. The electric power source of claim 1 including but not limited to: being deactivated by a time-out switch.

6. The electric power source of claim 1 including but not limited to: being powered or recharged by a solar panel or kinetic device that is optionally affixed to vehicle.

7. The electric power source of claim 1 including but not limited to: being powered by any other suitable power generation.

8. The bracket system of claim 1 including but not limited to brackets molded to fit the frame or form of the vehicle in an easy to apply fashion at factory or by consumer having two distinct elements.
The first element of the bracket being a clip, loop, or channel to hold EL wire or illuminated filament in place.
The second element of the bracket being a contact surface with adhesive, hook and loop, magnetic, or other means of adhering bracket to vehicle surface or part.

9. The bracket system of claim 1 including but not limited to: custom brackets designed to arrange EL wires or illuminated filaments in specific or user defined design configurations.

10. The bracket system of claim 1 including but not limited to: being molded into a sculptured form with transparent or translucent sections including a lighting element that can be plugged into or hardwired to the circuitry as an extension of the lighting system.

11. The unit of claim 1 optionally including or being a stand-alone unit for individual tires on the vehicle, steering wheel, or other independently moving vehicle component.

12. The bracket system of claim 1 including but not limited to: being brackets to easily affix unit to wheels, spokes, rims, hubcaps, steering wheel, dashboard, window, mirror, glove-box, antenna, or other independent vehicle component.

13. Any or all parts of the unit of claim 1 optionally being embedded in the frame, body, spokes, rims, hubcaps, rubber of tire or other component of vehicle.

14. Any or all parts of the unit of claim 1 being weather proofed and water resistant by sealing all connections, circuitry, and battery housings.

15. The lighting element and circuitry of claim 1 optionally being of a modular and expandable design by utilizing a configurable system of water resistant male and female plugs.

16. The lighting element and circuitry of claim 1 optionally being hardwired into an unalterable and closed ended circuit.

17. The lighting element and circuitry of claim 1 optionally incorporating LEDs, other illuminated and/or electronic devices for added design, visibility, or functionality.
